(19) United States
(12) Patent Application Publication
(10) Pub. No.: US 2011/0203373 A1
(43) Pub. Date: Aug. 25, 2011

(54) ACCELERATION SENSOR

(75) Inventor: Nobuaki Konno, Tokyo (JP)

(73) Assignee: MITSUBISHI ELECTRIC CORPORATION, Tokyo (JP)

(21) Appl. No.: 13/127,172

(22) PCT Filed: Aug. 13, 2009
(86) PCT No.: PCT/JP2009/064291

§ 371 Date: May 2, 2011

(30) Foreign Application Priority Data
Nov. 13, 2008 (JP) 2008-291224

(51) Int. Cl. G01P 15/125

(52) U.S. Cl. 73/514.32

(57) ABSTRACT

An acceleration sensor includes a substrate, and a plurality of acceleration detection units supported by the substrate. Each of the plurality of acceleration detection units has a torsion beam supported by the substrate and distorted about a torsion axis line; a detection frame supported by the torsion beam so as to be rotatable about the torsion axis line; a detection electrode formed on the substrate so as to face the detection frame; a link beam supported by the detection frame at a position on an axis line deviated from the torsion axis line when seen in plane; and an inertia mass body supported by the link beam so as to be displaceable in a thickness direction of the substrate. The plurality of acceleration detection units include first and second acceleration detection units. The first and second acceleration detection units are disposed side by side along a direction of the first torsion axis line. Thereby, a highly accurate acceleration sensor that suppresses a vibration with a high frequency and a high acceleration can be obtained.

### TECHNICAL FIELD

The present invention relates to an acceleration sensor, and more particularly to an electrostatic capacitance type acceleration sensor.

### BACKGROUND ART

As one of the principles of a conventional acceleration sensor for detecting acceleration in the substrate thickness direction, there is a method for detecting a change in electrostatic capacitance in accordance with the acceleration. As an acceleration sensor based on this method, an acceleration sensor (an acceleration sensing motion converter) including, for example, a torsion beam (a deflecting part), an inertia mass body (a weight), a detection frame (an element), and a detection electrode (a sensing electrode) as main components has been known (see for example Japanese Patent Laying-Open No. 5-133976 (Patent Document 1)).

The acceleration sensor (acceleration sensing motion converter) of Patent Document 1 has one detection frame (element) having a surface facing a substrate. The inertia mass body (weight) is provided on one end of the detection frame (element). The detection frame (element) is supported on the substrate so as to be rotatable with the torsion beam (deflecting part) as the axis of rotation. The detection electrode (sensing electrode) for detecting this rotational displacement is provided under the detection frame (element).

When acceleration in the substrate thickness direction is applied to the acceleration sensor constituted as described above, inertia force in the substrate thickness direction acts on the inertia mass body (weight). Since the inertia mass body (weight) is provided on the one end, that is, at a position deviated from the axis of rotation in the substrate in-plane direction, this inertia force acts on the detection frame (element) as torque around the torsion beam (deflecting part). As a result, the detection frame (element) is rotationally displaced.

The distance between the detection frame (element) and the detection electrode (sensing electrode) is changed by this rotational displacement, which causes a change in electrostatic capacitance of a capacitor formed by the detection frame (element) and the detection electrode (sensing electrode). The acceleration is measured from this change in electrostatic capacitance.

Further, an electrostatic capacitance type acceleration sensor in which an inertia mass body is disposed in the same plane as a detection frame, instead of being disposed on the detection frame, and is connected at a link beam and thus a process is simplified has been known. In this acceleration sensor, detection electrodes are provided to be sensitive only to rotational displacements of a plurality of detection frames in directions opposite to each other (see for example Japanese Patent Laying-Open No. 2008-139282 (Patent Document 2)). Thereby, the acceleration sensor of Patent Document 2 can suppress sensitivity to acceleration in a direction which is not a target direction for detection, and can be less affected by angular velocity and angular acceleration. That is, in the acceleration sensor of Patent Document 2, the accuracy of measuring acceleration is improved by using the plurality of detection frames.

### PRIOR ART DOCUMENTS

### Patent Documents

Patent Document 1: Japanese Patent Laying-Open No. 5-133976
Patent Document 2: Japanese Patent Laying-Open No. 2008-139282

### SUMMARY OF THE INVENTION

### Problems to be Solved by the Invention

In a case where a plurality of detection frames are used in an acceleration sensor as in the conventional technique described above, the respective detection frames have a shorter length depending on the shape of the acceleration sensor. If the detection frames have a shorter length, the detection frames have a smaller inertia moment. Thereby, the detection frames have a higher resonance frequency. Thus, the acceleration sensor having the detection frames has a higher resonance frequency.

If the resonance frequency of the acceleration sensor is increased, a frequency measurement range can be widened. However, in a case where the resonance frequency of the acceleration sensor is higher than necessary, if a vibration with a high frequency and a high acceleration caused for example at the time of collision of an object is applied, the vibration may not be attenuated. Thereby, the vibration with a high frequency and a high acceleration may exceed an acceleration measurement range of the acceleration sensor. Thus, an output error may occur in the acceleration sensor.

To lower the resonance frequency of the detection frame, it is effective to increase the size of the detection frame. However, if the size of the conventional detection frame disclosed in Patent Documents 1 and 2 is simply increased, there arises many problems such that the number of the detection frames to be obtained is decreased, and that an influence of warpage due to residual stress generated in a film constituting the detection frame becomes evident.

The present invention has been made in view of the above problems, and one object of the present invention is to provide a highly accurate acceleration sensor suppressing a vibration with a high frequency and a high acceleration without causing an increase in the size of the acceleration sensor.

### Means for Solving the Problems

An acceleration sensor of the present invention includes a substrate, and a plurality of acceleration detection units supported by the substrate. Each of the plurality of acceleration detection units has a torsion beam supported by the substrate and distorted about a torsion axis line, a detection frame supported by the torsion beam so as to be rotatable about the torsion axis line, a detection electrode formed on the substrate so as to face the detection frame, a link beam supported by the detection frame at a position on an axis line deviated from the torsion axis line when seen in plane, and an inertia mass body supported by the link beam so as to be displaceable in a thickness direction of the substrate. The plurality of acceleration detection units include first and second acceleration detection units. The first and second acceleration detection units are disposed side by side along a direction of the torsion axis line of the first acceleration detection unit.

### Effects of the Invention

According to the acceleration sensor of the present invention, since the first and second acceleration detection units are arranged side by side along the direction of the torsion axis line, the detection frames of the acceleration detection units can have a longer length without causing an increase in the size of the acceleration sensor, when compared with a case where the first and second acceleration detection units are arranged in a direction perpendicular to the direction of the axis line. Thus, the detection frames can have a larger inertia moment, and thereby have a lower resonance frequency. Therefore, the vibration with a high frequency and a high acceleration can be readily suppressed.

Further, since the detection frames are long, the degree of freedom of the positions of the link beams is increased. Thereby, the degree of freedom in designing the acceleration sensor can be increased.

### BRIEF DESCRIPTION OF THE DRAWINGS

FIG. 1 is a top view schematically showing a constitution of an acceleration sensor according to Embodiment 1 of the present invention.

FIG. 2 is a schematic cross sectional view along a line II-II in FIG. 1.

FIG. 3(A) is a cross sectional view which schematically shows a state where acceleration is applied upward along the film thickness direction of a substrate to the acceleration sensor according to Embodiment 1 of the present invention, and corresponds to a cross section along line II-II in FIG. 1, and FIG. 3(B) is a view which corresponds to a cross section along a line III-III in FIG. 1.

FIG. 4 is a circuit diagram explaining electrical connection between capacitors formed by first and second detection frames and detection electrodes of the acceleration sensor according to Embodiment 1 of the present invention.

FIG. 5 is a schematic cross sectional view which shows a first step of a method for manufacturing the acceleration sensor according to Embodiment 1 of the present invention, and whose cross sectional position corresponds to a cross sectional position in FIG. 2.

FIG. 6 is a schematic cross sectional view which shows a second step of the method for manufacturing the acceleration sensor according to Embodiment 1 of the present invention, and whose cross sectional position corresponds to the cross sectional position in FIG. 2.

FIG. 7 is a schematic cross sectional view which shows a third step of the method for manufacturing the acceleration sensor according to Embodiment 1 of the present invention, and whose cross sectional position corresponds to the cross sectional position in FIG. 2.

FIG. 8 is a schematic cross sectional view which shows a fourth step of the method for manufacturing the acceleration sensor according to Embodiment 1 of the present invention, and whose cross sectional position corresponds to the cross sectional position in FIG. 2.

FIG. 9 is a schematic cross sectional view which shows a fifth step of the method for manufacturing the acceleration sensor according to Embodiment 1 of the present invention, and whose cross sectional position corresponds to the cross sectional position in FIG. 2.

FIG. 10(A) is a schematic view which shows a structure of a detection frame and shows a conventional structure, and FIG. 10(B) is a view which shows a structure of Embodiment 1.

FIG. 11 is a view showing the relationship between frequency and amplitude in the conventional structure and the structure of Embodiment 1.

FIG. 12(A) is a cross sectional view which schematically shows a state where angular acceleration is applied to the acceleration sensor according to Embodiment 1 of the present invention, and corresponds to the cross section along line II-II in FIG. 1, and FIG. 12(B) is a view which corresponds to the cross section along line in FIG. 1.

FIG. 13(A) is a cross sectional view which schematically shows a state where angular velocity is applied to the acceleration sensor according to Embodiment 1 of the present invention, and corresponds to the cross section along line II-II in FIG. 1, and FIG. 13(B) is a view which corresponds to the cross section along line in FIG. 1.

FIG. 14(A) is a cross sectional view which schematically shows a state where acceleration in the Y axis direction is applied to the acceleration sensor according to Embodiment 1 of the present invention, and corresponds to the cross section along line II-II in FIG. 1, and FIG. 14(B) is a view which corresponds to the cross section along line III-III in FIG. 1.

FIG. 15 is a top view schematically showing a constitution of an acceleration sensor according to Embodiment 2 of the present invention.

### MODES FOR CARRYING OUT THE INVENTION

In the following, embodiments according to the present invention will be described with reference to the drawings.

### Embodiment 1

Firstly, a main constitution of an acceleration sensor according to the present embodiment will be described.

For convenience of explanation, coordinate axes of the X axis, the Y axis and the Z axis are introduced. In FIG. 1, the X axis is an axis in which the right direction along the lateral direction is the positive direction, the Y axis is an axis in which the upper direction along the longitudinal direction is the positive direction, and the Z axis is an axis which is vertical to the paper surface and in which the upper direction is the positive direction. It is to be noted that the direction of the Z axis coincides with the acceleration direction to be measured by the acceleration sensor according to the present embodiment.

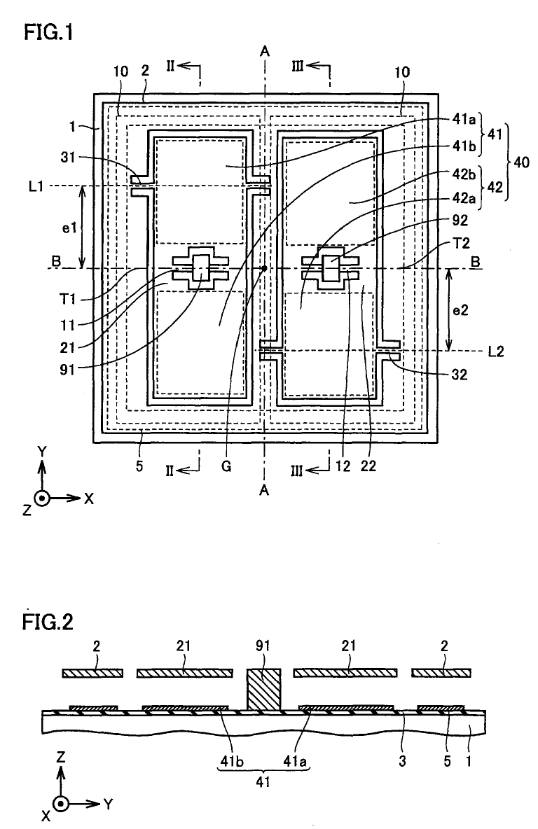

Referring to FIGS. 1 and 2, the acceleration sensor according to the present embodiment mainly includes a substrate 1, and a plurality of acceleration detection units 10.

A silicon substrate can be used as substrate 1. Further, a polysilicon film can be used as a material for first and second torsion beams 11 and 12, first and second detection frames 21 and 22, first and second link beams 31 and 32, an inertia mass body 2, a detection electrode 40, and an actuation electrode 5. It is desirable that the polysilicon film has low stress and no stress distribution in the thickness direction thereof.

The plurality of acceleration detection units 10 include, for example, a first acceleration detection unit 10 and a second acceleration detection unit 10. The first and second acceleration detection units 10 are supported by substrate 1.

The first acceleration detection unit 10 has the first torsion beam 11, the first detection frame 21, a first detection electrode 41, the first link beam 31, and inertia mass body 2.

The first torsion beam 11 is supported by substrate 1 with an anchor 91 so as to be distorted about a first torsion axis line T1 along the X axis.

The first detection frame 21 is supported by substrate 1 via the first torsion beam 11 so as to be rotatable about the first torsion axis line T1. Further, at least a part of the first detection frame 21 has conductivity.

A plurality of detection electrodes 40 have the first detection electrode 41 and a second detection electrode 42. The first detection electrode 41 is formed on substrate 1 with an insulating film 3 interposed therebetween so as to face the first detection frame 21 in order to enable an angle formed between substrate 1 and the first detection frame 21 to be detected on the basis of electrostatic capacitance. It is to be noted that a silicon nitride film or a silicon oxide film having low stress is suitable as insulating film 3.

The first link beam 31 is supported by the first detection frame 21 at a position on an axis line deviated from torsion axis line T1 when seen in plane. More specifically, the first link beam 31 is provided to the first detection frame 21 at a position on an axis L1 which is located at a position shifted in parallel from a position of the first torsion axis line T1 to one end side of the first detection frame 21 by an offset e1, along a direction crossing the first torsion axis line T1. That is, the absolute value of offset e1 is a dimension between the first torsion axis line T1 and the first link beam 31, and the direction of offset e1 is the direction crossing the first torsion axis line T1 and directed from the first torsion axis line T1 to axis L1.

Inertia mass body 2 is supported above substrate 1 so as to be displaceable in the thickness direction of substrate 1, by being linked to the first detection frame 21 via the first link beam 31.

The second acceleration detection unit 10 has the same constitution as that of the first acceleration detection unit 10. That is, the second acceleration detection unit has the second torsion beam 12, the second detection frame 22, the second detection electrode 42, the second link beam 32, and inertia mass body 2.

The second torsion beam 12 is supported by substrate 1 with an anchor 92 so as to be distorted around a second torsion axis line T2 along the X axis.

The second detection frame 22 is supported by substrate 1 via the second torsion beam 12 so as to be rotatable about the second torsion axis line T2. Further, at least a part of the second detection frame 22 has conductivity.

The second detection electrode 42 is formed on substrate 1 with insulating film 3 interposed therebetween so as to face the second detection frame 22 in order to enable an angle formed between substrate 1 and the second detection frame 22 to be detected on the basis of electrostatic capacitance.

The second link beam 32 is supported by the second detection frame 22 at a position on an axis line deviated from the second torsion axis line T2 when seen in plane. More specifically, the second link beam 32 is provided to the second detection frame 22 at a position on an axis L2 which is located at a position deviated in parallel from a position of the second torsion axis line T2 by an offset e2, in a direction opposite to the direction of shift described above, that is, in a direction opposite to the direction of offset e1. That is, the absolute value of offset e2 is a dimension between the second torsion axis line T2 and the second link beam 32, and the direction of offset e2 is opposite to the direction of offset e1.

Inertia mass body 2 is supported above substrate 1 so as to be displaceable in the thickness direction of substrate 1, by being linked to the second detection frame 22 via the second link beam 32.

The first acceleration detection unit 10 and the second acceleration detection unit 10 are disposed side by side along the direction of the first torsion axis line T1 of the first acceleration detection unit 10. More specifically, the first acceleration detection unit 10 and the second acceleration detection unit 10 are disposed such that the long side of detection frame 21 of the first acceleration detection unit 10 faces the long side of detection frame 22 of the second acceleration detection unit 10. It is to be noted that there is no other acceleration detection unit 10 in a direction perpendicular to the first torsion axis line T1.

Preferably, link beam 31 of the first acceleration detection unit 10 is disposed on one side with respect to torsion axis line T1 of the first acceleration detection unit 10 when seen in plane, and link beam 32 of the second acceleration detection unit 10 is disposed on the other side with respect to torsion axis line T1 of the first acceleration detection unit 10 when seen in plane.

Preferably, the first and second torsion beams 11, 12 and the first and second link beams 31, 32 are disposed such that the absolute values of offsets e1 and e2 have an equal amount. That is, preferably, they are disposed such that dimensions of offset amounts therebetween are equal to each other.

Preferably, the first detection frame and the second detection frame are disposed in parallel to an axis A crossing a center line B when seen in plane. That is, preferably, the first and second torsion axis lines T1, T2 are disposed to be parallel to each other.

Preferably, the first torsion axis line T1 and the second torsion axis line T2 are disposed to be line symmetrical with respect to center line A in the Y axis direction passing through the center of gravity G of inertia mass body 2 when seen in plane.

Preferably, the first torsion axis line T1 and the second torsion axis line T2 are disposed to extend along center line B in the X axis direction passing through the center of gravity G of inertia mass body 2 when seen in plane.

More preferably, the planar layout of the acceleration sensor has a structure which is rotationally symmetrical by 180 degrees with respect to the center of gravity G of inertia mass body 2 when seen in plane.

It is to be noted that, although the first and second acceleration detection units 10 each have inertia mass body 2, inertia mass bodies 2 are integrally formed.

Further, actuation electrode 5 is formed on substrate 1 with insulating film 3 interposed therebetween so as to face inertia mass body 2, in order to enable inertia mass body 2 to be displaced on the basis of electrostatic force.

Subsequently, details of a constitution of detection electrode 40 described above, and a principle that allows the angle between substrate 1 and each of the first and second detection frames 21 and 22 to be detected by detection electrode 40 will be described.

Detection electrode 40 has the first detection electrode 41 facing the first detection frame 21. The first detection electrode 41 has detection electrodes 41a and 41b so as to sandwich the first torsion axis line T1 therebetween. Detection electrode 41a is positioned on the positive side of the Y axis (upper side in FIG. 1) of the acceleration sensor, and detection electrode 41b is positioned on the negative side of the Y axis (lower side in FIG. 1) of the acceleration sensor. Detection electrodes 41a and 41b are provided so as to sandwich the first torsion axis line T1 therebetween.

When the first detection frame 21 is rotated around the first torsion beam 11, a rear surface of the first detection frame 21 (a surface facing the first detection electrode 41) approaches one of detection electrodes 41a and 41b and recedes from the other detection electrode. Thus, it is possible to detect an angle between the first detection frame 21 and substrate 1 by detecting a difference between electrostatic capacitance formed by making the first detection frame 21 face detection electrode 41a and electrostatic capacitance formed by making the first detection frame 21 face detection electrode 41b.

Further, detection electrode 40 has the second detection electrode 42 facing the second detection frame 22. The second detection electrode 42 has detection electrodes 42a and 42b so as to sandwich the second torsion axis line T2 therebetween. Detection electrode 42a is positioned on the negative side of the Y axis (lower side in FIG. 1) of the acceleration sensor, and detection electrode 42b is positioned on the positive side of the Y axis (upper side in FIG. 1) of the acceleration sensor. Detection electrodes 42a and 42b are provided so as to sandwich the second torsion axis line T2 therebetween.

When the second detection frame 22 is rotated around the second torsion beam 12, a rear surface of the second detection frame 22 (a surface facing detection electrode 42) approaches one of detection electrodes 42a and 42b and recedes from the other detection electrode. Thus, it is possible to detect an angle between the second detection frame 22 and substrate 1 by detecting a difference between electrostatic capacitance formed by making the second detection frame 22 face detection electrode 42a and electrostatic capacitance formed by making the second detection frame 22 face detection electrode 42b.

Subsequently, a principle of measuring acceleration by the acceleration sensor according to the present embodiment will be described.

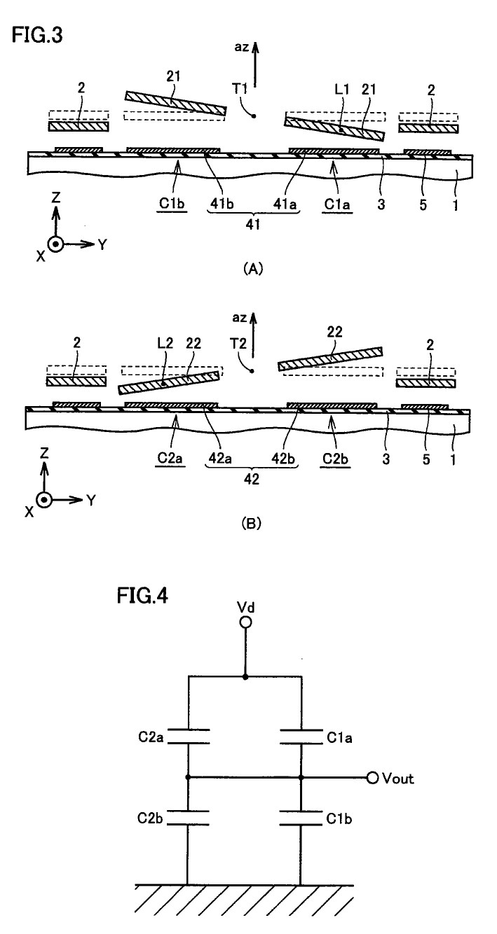

The cross sectional position in FIG. 3(A) is identical to that in FIG. 2. Further, in FIG. 3, anchors 91 and 92 are not shown for the sake of clarity.

Referring to FIGS. 3(A) and 3(B), when acceleration az in the upward direction along the film thickness direction of substrate 1, that is, in the positive direction (upward direction in the figure) of the Z axis, is applied to the acceleration sensor, inertia mass body 2 is displaced by inertia force so as to be sunk in the negative direction (downward direction in the figure) of the Z axis, from an initial position (position shown by broken lines in the figure). The first and second link beams 31 and 32 which are linked with inertia mass body 2 are also displaced integrally with inertia mass body 2 in the negative direction (downward direction in the figure) of the Z axis.

Due to the displacement of the first link beam 31, the first detection frame 21 receives force in the negative direction (downward direction in the figure) of the Z axis by a part of axis L1. Axis L1 is located at the position shifted in parallel from the first torsion axis line T1 by offset e1, which causes torque to act on the first detection frame 21. As a result, the first detection frame 21 is rotationally displaced.

Further, due to the displacement of the second link beam 32, the second detection frame 22 receives force in the negative direction (downward direction in the figure) of the Z axis by a part of axis L2. Axis L2 is located at the position shifted in parallel from the second torsion axis line T2 by offset e2, which causes torque to act on the second detection frame 22. As a result, the second detection frame 22 is rotationally displaced.

Since offsets e1 and e2 are directed in the opposite directions, the first detection frame 21 and the second detection frame 22 are rotated in the opposite directions. That is, the first and second detection frames 21 and 22 are rotationally displaced in such a manner that an upper surface of the first detection frame 21 is directed toward one end side (right-hand side in FIG. 3(A)) of the acceleration sensor, and an upper surface of the second detection frame 22 is directed toward one end side (left-hand side in FIG. 3(B)) of the acceleration sensor.

In accordance with this rotational displacement, electrostatic capacitance C₁ₐ of a capacitor C1a formed by the first detection frame 21 and detection electrode 41a is increased, and electrostatic capacitance C_{1b} of a capacitor C1b formed by the first detection frame 21 and detection electrode 41b is decreased. Further, electrostatic capacitance C₂ₐ of a capacitor C2a formed by the second detection frame 22 and detection electrode 42a is increased, and electrostatic capacitance C_{2b} of a capacitor C2b formed by the second detection frame 22 and detection electrode 42b is decreased.

Referring to FIG. 4, capacitors C 1a and C2a are connected in parallel, and capacitors C1b and C2b are connected in parallel. Then, the two parallel connection parts are further connected in series. A constant potential Vd is applied to an end on the side of capacitors C1a and C2a of the circuit formed in this way, and an end on the side of capacitors C1b and C2b is grounded. The above described series connection part is provided with a terminal, whose output potential Vout can be measured. Output potential Vout takes a value obtained from the following formula:

$${V}_{out} = \frac{{C}_{1 a} + {C}_{2 a}}{( {C}_{1 a} + {C}_{2 a} ) + ( {C}_{1 b} + {C}_{2 b} )} {V}_{d} \qquad ( 1 )$$

Since potential Vd is a constant value, acceleration az in the Z axis direction can be sensed by measuring output potential Vout. If acceleration is 0, that is, there is no displacement, Vout can be represented as Vout=Vd/2, because C₁ₐ=C₂ₐ=C_{1b}=C_{2b}.

Subsequently, a method for manufacturing the acceleration sensor according to the present embodiment will be described.

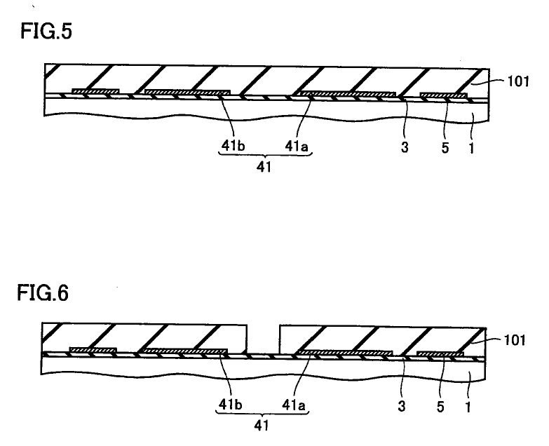

FIGS. 5 to 9 are schematic cross sectional views which sequentially show first to fifth steps of a method for manufacturing the acceleration sensor according to Embodiment 1 of the present invention, and whose cross sectional positions correspond to a cross sectional position in FIG. 2. Hereinafter, formation of inertia mass body 2, the first link beam 31, the first detection frame 21, the first torsion beam 11, and anchor 91 will be described. It is to be noted that the second link beam 32, the second detection frame 22, and the second torsion beam 12 are also formed in the same manner.

Referring to FIG. 5, insulating film 3 is deposited on substrate 1 made of silicon by the LPCVD (Low Pressure Chemical Vapor Deposition) method. As insulating film 3, a silicon nitride film, a silicon oxide film and the like which have low stress are suitably used. On insulating film 3, an electroconductive film made of for example, polysilicon is deposited by the LPCVD method. Subsequently, the electroconductive film is patterned so that detection electrode 40 and actuation electrode 5 are formed. Then, a PSG (Phosphosilicate Glass) film 101 is deposited on the whole surface of substrate 1.

Referring mainly to FIG. 6, a part of PSG film 101 in which anchor 91 (FIG. 2) is to be formed is selectively removed.

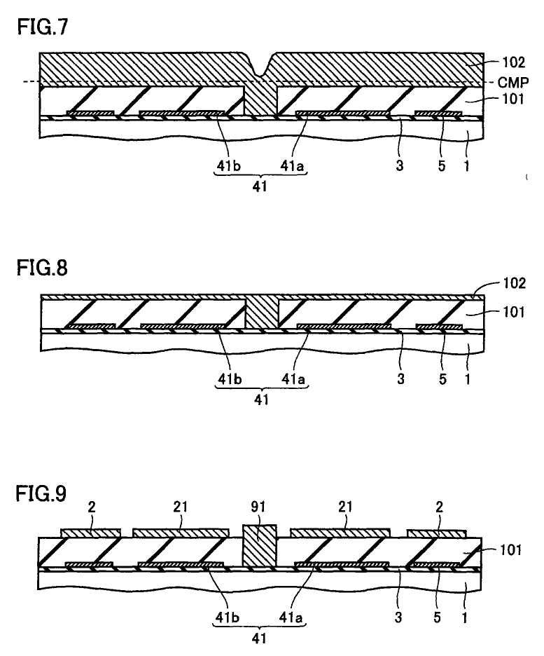

Referring to FIG. 7, a polysilicon film 102 is deposited on the whole surface of substrate 1. Subsequently, CMP (Chemical Mechanical Polishing) processing is performed to the surface of polysilicon film 102.

Referring to FIG. 8, the surface of polysilicon film 102 is planarized by the above described CMP processing.

Referring to FIG. 9, selective etching is performed to the part of polysilicon film 102 above an upper surface of PSG film 101. Thereby, inertia mass body 2, the first link beam 31 (FIG. 1), the first detection frame 21, the first torsion beam 11 (FIG. 1), and anchor 91 are collectively formed. Then, PSG film 101 is removed by etching, and the acceleration sensor according to the present embodiment shown in FIG. 2 is obtained.

Next, the function and effect of the acceleration sensor according to the present embodiment will be described.

Firstly, a resonance frequency of the acceleration sensor according to the present embodiment will be described to explain the function and effect of the acceleration sensor according to the present embodiment.

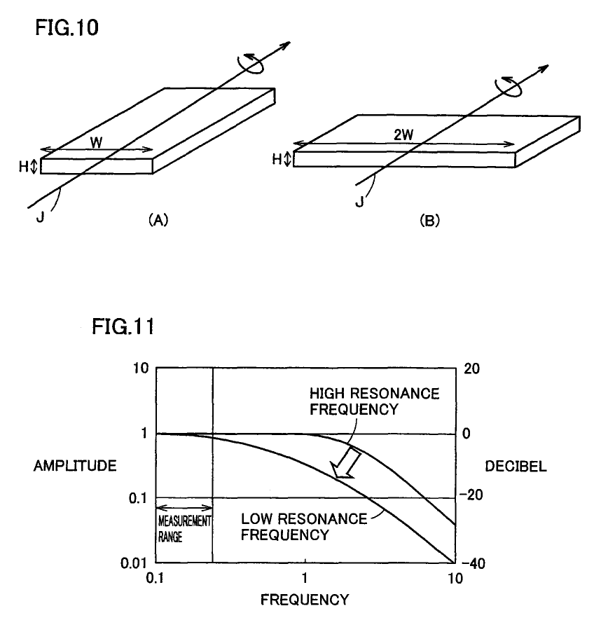

In both structures having the same mass m shown in FIGS. 10(A) and 10(B), H indicates a thickness, W indicates a width of the structure of a conventional detection frame, and 2W indicates a width of the structure of the detection frame according to the present embodiment. Generally, a resonance frequency f of a rotating structural body is represented by the following formula:

$$f = \frac{1}{2 π} \sqrt{\frac{K}{I}} \qquad ( 2 )$$

Here, K indicates rigidity of a beam, and I indicates an inertia moment around an axis J which passes through the center of gravity of the structural body and is perpendicular to an H-by-W plane. Although the resonance frequency is actually not so simple as represented by formula (2) because the acceleration sensor according to the present embodiment has a second-order spring-mass structure, it will be simply described as being equivalent to formula (2). An inertia moment I1 of the structure of the conventional detection frame and an inertia moment I2 of the structure of the detection frame according to the present embodiment are represented by the following formulas:

$$\begin{matrix}I 1 = \frac{{H}^{2} + {W}^{2}}{12} m & ( 3 ) \\ I 2 = \frac{{H}^{2} + 4 {W}^{2}}{12} m & ( 4 )\end{matrix}$$

Formulas (3) and (4) indicate that, if thickness H is small enough with respect to width W, inertia moment I2 of the structure of the detection frame according to the present embodiment is four times larger than inertia moment I1 of the structure of the conventional detection frame. In this case, as can be seen from formula (2), the resonance frequency of the structure of the detection frame according to the present embodiment is half the resonance frequency of the structure of the conventional detection frame.

Subsequently, an example where a vibration with a high frequency and a high acceleration is applied to the acceleration sensor according to the present embodiment will be described.

FIG. 11 shows the relationship between frequency of input acceleration and output amplitude due to a difference in resonance frequency.

An equation of motion in this case is represented by the following formula:

I\ddot{θ}+C\dot{θ}+Kθ=M (5)

Here, I indicates an inertia moment, K indicates rigidity of a beam, θ indicates a rotation angle, C indicates an attenuation constant, and M indicates an input moment. In FIG. 11, inertia moment I and input moment M are set to 1, attenuation constant C is set to 3, rigidity K of a beam in the conventional structure is set to 4, and rigidity K of a beam in the structure according to the present embodiment is set to 1. In FIG. 11, a high resonance frequency represents the relationship between frequency of input acceleration and output amplitude in the conventional structure, and a low resonance frequency represents the relationship therebetween in the structure according to the present embodiment. Here, a frequency of 1 indicates a high frequency, and an amplitude of 1 indicates an amplitude in DC (direct current).

Referring to FIG. 11, within a measurement range of the acceleration sensor, an output remains within −3 decibels (dB). Generally, the acceleration sensor only needs to satisfy the specifications within this measurement range. However, in a case where a vehicle collides when the acceleration sensor is used as a vehicle-mounted sensor, the influence of a shock wave (with a high frequency and a high acceleration) on the acceleration sensor cannot be neglected. For example, if acceleration with a high frequency (a frequency of 1) is input in FIG. 11, an acceleration sensor having the conventional structure (high resonance frequency) has an amplitude of about 0.94, whereas an acceleration sensor having the structure according to the present embodiment (low resonance frequency) has an amplitude of about 0.33.

That is, an acceleration sensor having a high resonance frequency has a characteristic that a difference between a high frequency input and an output is small (that is, the input is less likely to be attenuated). On the other hand, an acceleration sensor having a low resonance frequency has a characteristic that a difference between a high frequency input and an output is large (that is, the input is likely to be attenuated).

Even with the conventional structure (high resonance frequency), there is no problem if acceleration is within the measurement range. However, in many cases, acceleration exceeding the measurement range is applied at the time of collision. Therefore, in the acceleration sensor having the conventional structure (high resonance frequency), acceleration exceeds a measurement limit thereof, which causes a malfunction of the acceleration sensor.

On the other hand, the acceleration sensor having the structure according to the present embodiment (low resonance frequency) has room several times that of the conventional structure (about three times (0.94/0.33) in the present embodiment) with respect to acceleration with a frequency of 1 (high frequency). Therefore, the acceleration sensor has a wide allowable acceleration range. That is, in the acceleration sensor having the structure according to the present embodiment (low resonance frequency), if an input outside of the measurement range is received, an output has a small amplitude (that is, the input is likely to be attenuated), and thus the acceleration sensor has a wide acceleration range in which no malfunction is caused.

As described above, according to the acceleration sensor of the present embodiment, the acceleration sensor can have a reduced resonance frequency, although it has the same size as the conventional acceleration sensor. Thereby, the acceleration sensor can attenuate a vibration with a high frequency, and suppress the vibration to be within an acceleration measurement range. Therefore, the acceleration measurement range in which no malfunction is caused can be widened without causing an increase in the size of the acceleration sensor.

In addition, since the detection frame according to the present embodiment is longer than the conventional detection frame, it has a wide range for connecting a link beam. This can increase the degree of freedom in designing the acceleration sensor. For example, sensitivity for measuring acceleration can be increased by connecting a link beam to an end of the detection frame. Further, sensitivity for measuring acceleration can be decreased by connecting a link beam to the vicinity of a torsion beam. The range for connecting a link beam in the structure of the detection frame according to the present embodiment can be about double that of the structure of the conventional detection frame.

Next, a detection error in a case where angular acceleration is applied to the acceleration sensor according to the present embodiment will be described.

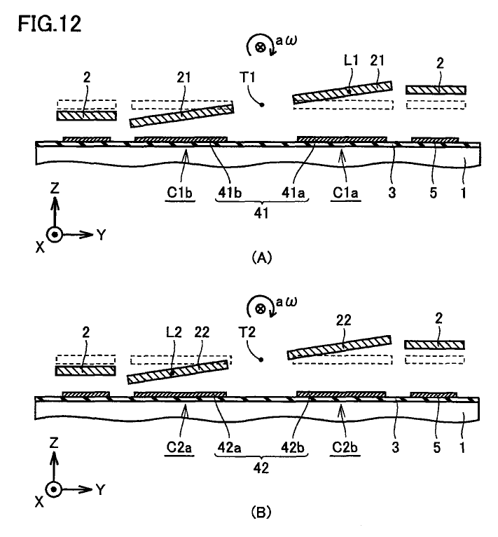

FIGS. 12(A), 13(A), and 14(A) are schematic cross sectional views along line II-II in FIG. 1. FIGS. 12(B), 13(B), and 14(B) are schematic cross sectional views along line III-III in FIG. 1. Further, in FIGS. 12(A) to 14(B), anchors 91 and 92 and inertia mass body 2 in the center are not shown for the sake of clarity.

Referring to FIG. 12(A), when inertia mass body 2 receives negative angular acceleration aω in the X axis direction, inertia mass body 2 is rotationally displaced by an inertia moment from the initial position (position shown by broken lines in the figure), in a direction opposite to the direction of angular acceleration aω, so that inertia mass body 2 is inclined. In accordance with the inclination of inertia mass body 2, the first detection frame 21 is raised by the part of axis L1 of the first link beam 31 and rotated about the first torsion axis line T1. Further, referring to FIG. 12(B), the second detection frame 22 is pressed down by the part of axis L2 of the second link beam 32 and rotated about the second torsion axis line T2.

In accordance with the rotation of the first and second detection frames 21 and 22, electrostatic capacitance C₁ₐ of capacitor C1a formed by the first detection frame 21 and detection electrode 41a is decreased, and electrostatic capacitance C_{1b} of capacitor C1b formed by the first detection frame 21 and detection electrode 41b is increased. Further, electrostatic capacitance C₂ₐ of capacitor C2a formed by the second detection frame 22 and detection electrode 42a is increased, and electrostatic capacitance C_{2b} of capacitor C2b formed by the second detection frame 22 and detection electrode 42b is decreased.

Referring to formula (1), when the above described changes in the electrostatic capacitances are caused, the decrease of electrostatic capacitance C₁ₐ and the increase of C₂ₐ are mutually canceled, and the increase of C_{1b} and the decrease of C_{2b} are mutually canceled. For this reason, the influence of angular acceleration aω on output potential Vout is suppressed.

Next, a detection error in a case where angular velocity is applied to the acceleration sensor according to the present embodiment will be described.

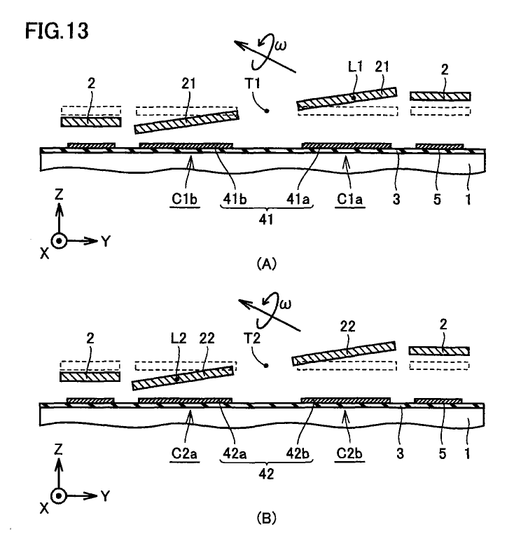

Referring to FIGS. 13(A) and 13(B), centrifugal force caused by rotation of angular velocity ω acts on inertia mass body 2. Thereby, inertia mass body 2 is rotationally displaced from the initial position (position shown by broken lines in the figure), in a direction in which the end of inertia mass body 2 is away from the axis of rotation of angular velocity ω, so that inertia mass body 2 is inclined.

The inclination of inertia mass body 2 is the same as that of the above described case where angular acceleration aω is applied. For this reason, the influence of angular velocity ω on output potential Vout is also suppressed on the basis of the same principle.

Next, a detection error in a case where acceleration along another axis is applied to the acceleration sensor according to the present embodiment will be described, including the influence of gravity.

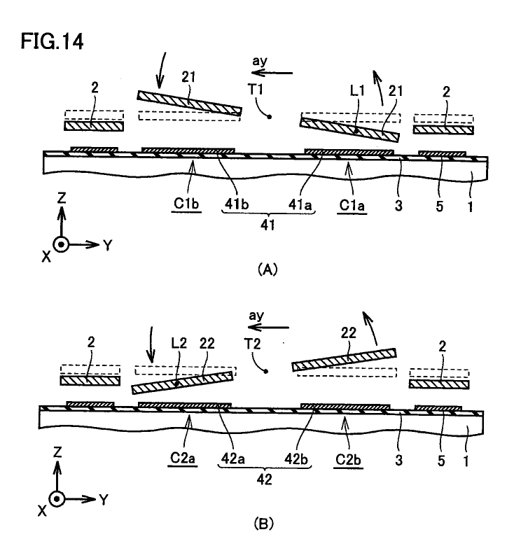

Referring to FIGS. 14(A) and 14(B), negative force in the Z axis direction acts as gravity on inertia mass body 2, so that inertia mass body 2 is in a state of being sunk downward (in the negative direction of the Z axis in the figure) from the initial position (position shown by broken lines in the figure).

In this state, when acceleration ay is applied to the acceleration sensor in the negative direction of the Y axis, inertia force in the positive direction of the Y axis is applied to inertia mass body 2. This inertia force is transmitted to the first and second detection frames 21 and 22 by the parts on axes L1 and L2 of the first and second link beams 31 and 32 (FIG. 1), respectively.

The height of axis L1 from substrate 1 is made smaller than that of the first torsion axis line T1 due to the influence of gravity. For this reason, the above described force transmitted to the part of axis L1 acts on the first detection frame 21 as torque around the first torsion axis line T1.

Further, the height of axis L2 from substrate 1 is made smaller than that of the second torsion axis line T2 due to the influence of gravity. For this reason, the above described force transmitted to the part of axis L2 acts on the second detection frame 22 as torque around the second torsion axis line T2.

Here, both of the above described torques around the first and second torsion axis lines T1 and T2 have action points below the first and second torsion axis lines T1 and T2. Further, both of the forces acting on the action points are directed in the positive direction in the Y axis direction. As a result, rotational displacement of the first detection frame 21 and rotational displacement of the second detection frame 22 are directed in the same direction.

Due to the influence of the rotational displacements, electrostatic capacitance C₁ₐ of capacitor C1a formed by the first detection frame 21 and detection electrode 41a is decreased, and electrostatic capacitance C_{1b} of capacitor C1b formed by the first detection frame 21 and detection electrode 41b is increased. Further, electrostatic capacitance C₂ₐ of capacitor C2a formed by the second detection frame 22 and detection electrode 42a is increased, and electrostatic capacitance C_{2b} of capacitor C2b formed by the second detection frame 22 and detection electrode 42b is decreased.

Referring to formula (1), when the changes in the above described electrostatic capacitances are caused, the decrease of electrostatic capacitance C₁ₐ and the increase of C₂ₐ are mutually canceled, and the increase of C_{1b} and the decrease of C_{2b} are mutually canceled. For this reason, the influence of acceleration ay in the Y axis direction on output potential Vout measured for detecting acceleration in the Z axis direction is suppressed.

According to the present embodiment, a detection error due to angular acceleration, angular velocity, and acceleration along another axis can be suppressed.

Preferably, in the present embodiment, offsets e1 and e2 shown in FIG. 1 are arranged to have absolute values equal to each other. Further, the first and second torsion axis lines T1 and T2 shown in FIG. 1 are arranged to be parallel to each other. Thereby, amounts of rotational displacements of the first and second detection frames 21 and 22 are made equal to each other. Thus, the electrostatic capacitances of capacitors C1a, C1b, C2a and C2b shown in FIG. 4 are changed more accurately. This enables the error of the acceleration sensor to be further suppressed.

According to the present embodiment, as shown in FIGS. 8 and 9, inertia mass body 2 serving as a movable part, the first link beam 31, the first detection frame 21, and the first torsion beam 11 are collectively formed from a film made of the same material. Therefore, since there is no joint part of different materials in the movable part, no distortion is generated due to a difference in thermal expansion coefficients of the different materials. This makes it possible to suppress the temperature dependence of the acceleration sensor.

Further, according to the present embodiment, electrostatic force pulling inertia mass body 2 toward substrate 1 can be generated by applying voltage to between actuation electrode 5 and inertia mass body 2. That is, inertia mass body 2 can be electrostatically driven in the film thickness direction of substrate 1. This electrostatic drive can cause displacement similar to the displacement of inertia mass body 2 in the case where acceleration az in the film thickness direction of substrate 1 is applied to the acceleration sensor. Therefore, the acceleration sensor can have a function of self-diagnosing whether the sensor has a failure without actually applying acceleration az to the acceleration sensor.

### Embodiment 2

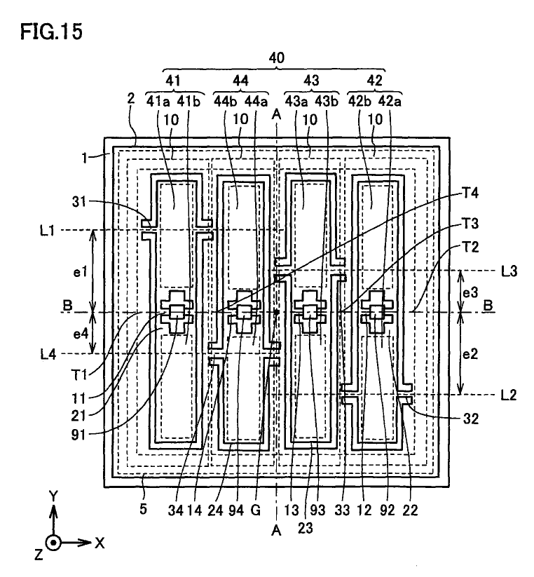

Referring to FIG. 15, an acceleration sensor according to the present embodiment is different from the constitution of Embodiment 1 mainly in the constitution of the plurality of acceleration detection units. The acceleration sensor according to the present embodiment has a third acceleration detection unit 10 and a fourth acceleration detection unit 10, in addition to the constitution of Embodiment 1.

The third acceleration detection unit 10 has a third torsion beam 13, a third detection frame 23, a third detection electrode 43, a third link beam 33, and inertia mass body 2.

The fourth acceleration detection unit 10 has a fourth torsion beam 14, a fourth detection frame 24, a fourth detection electrode 44, a fourth link beam 34, and inertia mass body 2.

The third torsion beam 13 is supported by substrate 1 with an anchor 93 so as to be distorted about a third torsion axis line T3 along the X axis.

The third detection frame 23 is supported by substrate 1 via the third torsion beam 13 so as to be rotatable about the third torsion axis line T3. Further, at least a part of the third detection frame 23 has conductivity.

The third detection electrode 43 is formed on substrate 1 with insulating film 3 interposed therebetween so as to face the third detection frame 23 in order to enable an angle formed between substrate 1 and the third detection frame 23 to be detected on the basis of electrostatic capacitance. The third detection electrode 43 has detection electrodes 43a and 43b so as to sandwich the third torsion axis line T3 therebetween. The third link beam 33 is supported by the third detection frame 23 at a position on an axis line deviated from torsion axis line T3 when seen in plane. More specifically, the third link beam 33 is provided to the third detection frame 23 at a position on an axis L3 which is located at a position shifted in parallel from a position of the third torsion axis line T3 to one end side of the third detection frame 23 by an offset e3, along a direction crossing the third torsion axis line T3. That is, the absolute value of offset e3 is a dimension between the third torsion axis line T3 and the third link beam 33, and the direction of offset e3 is the direction crossing the third torsion axis line T3 and directed from the third torsion axis line T3 to axis L3.

Inertia mass body 2 is supported above substrate 1 so as to be displaceable in the thickness direction of substrate 1, by being linked to the third detection frame 23 via the third link beam 33.

The fourth acceleration detection unit 10 has the same constitution as that of the third acceleration detection unit 10. Specifically, the fourth acceleration detection unit has a fourth torsion beam 14, a fourth detection frame 24, a fourth detection electrode 44, a fourth link beam 34, and inertia mass body 2.

The fourth torsion beam 14 is supported by substrate 1 with an anchor 94 so as to be distorted around a fourth torsion axis line T4 along the X axis. The fourth detection frame 24 is supported by substrate 1 via the fourth torsion beam 14 so as to be rotatable about the fourth torsion axis line T4. Further, at least a part of the fourth detection frame 24 has conductivity.

The fourth detection electrode 44 is formed on substrate 1 with insulating film 3 interposed therebetween so as to face the fourth detection frame 24 in order to enable an angle formed between substrate 1 and the fourth detection frame 24 to be detected on the basis of electrostatic capacitance. The fourth detection electrode 44 has detection electrodes 44a and 44b so as to sandwich the fourth torsion axis line T4 therebetween.

The fourth link beam 34 is supported by the fourth detection frame 24 at a position on an axis line deviated from torsion axis line T4 when seen in plane. More specifically, the fourth link beam 34 is provided to the fourth detection frame 24 at a position on an axis L4 which is located at a position deviated in parallel from a position of the fourth torsion axis line T4 by an offset e4, in a direction opposite to the direction of shift described above, that is, in a direction opposite to the direction of offset e3. That is, the absolute value of offset e4 is a dimension between the fourth torsion axis line T4 and the fourth link beam 34, and the direction of offset e4 is opposite to the direction of offset e3.

Inertia mass body 2 is supported above substrate 1 so as to be displaceable in the thickness direction of substrate 1, by being linked to the fourth detection frame 24 via the fourth link beam 34.

The third acceleration detection unit 10 and the fourth acceleration detection unit 10 are disposed side by side along the direction of the first torsion axis line T1 of the first acceleration detection unit 10.

In a method for manufacturing the acceleration sensor according to the present embodiment, selective etching is performed to the part of polysilicon film 102 above the upper surface of PSG film 101 in Embodiment 1, and thereby the third and fourth detection frames 23, 24, the third and fourth torsion beams 13, 14, and the third and fourth link beams 33, 34 are also collectively formed.

Since the constitution and the manufacturing method according to the present embodiment are the same as the constitution of Embodiment 1 described above except for the points described above, the same components will be denoted by the same reference numerals, and the description thereof will not be repeated.

According to the present embodiment, if acceleration in the thickness direction of substrate 1 is applied, the first and second detection frames 21, 22 and the third and fourth detection frames 23, 24 have different angles, and thus detection ranges of the detection frames can be changed. Referring to FIG. 15, for example, if low acceleration is applied, angles of the first and second detection frames 21, 22 in which the link beam is connected to the end are detected, and if high acceleration is applied, angles of the third and fourth detection frames 23, 24 are detected, and thereby a highly accurate acceleration detection range can be widened.

Although the above embodiments have explained the case where the first and second link beams 31, 32 are disposed on one side and on the other side of the long sides of the first and second detection frames 21, 22, respectively, the first and second link beams 31, 32 may be disposed on only one side of the long sides of the first and second detection frames 21, 22.

It should be understood that the embodiments disclosed herein are illustrative and non-restrictive in every respect. The scope of the present invention is defined by the scope of the claims, rather than the above description, and is intended to include any modifications within the scope and meaning equivalent to the scope of the claims.

### INDUSTRIAL APPLICABILITY

The present invention is particularly advantageously applicable to an electrostatic capacitance type acceleration sensor.

### DESCRIPTION OF THE REFERENCE SIGNS

1: substrate, 2: inertia mass body, 5: actuation electrode, 11: the first torsion beam, 12: the second torsion beam, 13: the third torsion beam, 14: the fourth torsion beam, 21: the first detection frame, 22: the second detection frame, 23: the third detection frame, 24: the fourth detection frame, 31: the first link beam, 32: the second link beam, 33: the third link beam, 34: the fourth link beam, 40: detection electrode, 91, 92, 93, 94: anchor.

1. An acceleration sensor, comprising:
a substrate; and
a plurality of acceleration detection units supported by said substrate,
each of said plurality of acceleration detection units having:
a torsion beam supported by said substrate and distorted about a torsion axis line;
a detection frame supported by said torsion beam so as to be rotatable about said torsion axis line;
a detection electrode formed on said substrate so as to face said detection frame;
a link beam supported by said detection frame at a position on an axis line deviated from said torsion axis line when seen in plane; and
an inertia mass body supported by said link beam so as to be displaceable in a thickness direction of said substrate,
said plurality of acceleration detection units including first and second acceleration detection units,
said first and second acceleration detection units being disposed side by side along a direction of said torsion axis line of said first acceleration detection unit.

2. The acceleration sensor according to claim 1, wherein said link beam of said first acceleration detection unit is disposed on one side with respect to said torsion axis line of said first acceleration detection unit when seen in plane, and said link beam of said second acceleration detection unit is disposed on the other side with respect to said torsion axis line of said first acceleration detection unit when seen in plane.

3. The acceleration sensor according to claim 1, wherein dimensions of offset amounts between said torsion beams and said link beams of said plurality of acceleration detection units are equal to each other.

4. The acceleration sensor according to claim 1, wherein said torsion axis lines of said plurality of acceleration detection units are parallel to each other.

5. The acceleration sensor according to claim 1, wherein
said plurality of acceleration detection units further include third and fourth acceleration detection units, and
said first to fourth acceleration detection units are disposed side by side along the direction of said torsion axis line of said first acceleration detection unit.
